(19) United States
(12) Patent Application Publication
(10) Pub. No.: US 2023/0126394 A1
(43) Pub. Date: Apr. 27, 2023

(54) Electrochemical system with an electrochemical stack for carbon dioxide capture and regeneration

(71) Applicant: Molten Industries Inc., Oakland, CA (US)

(72) Inventors: Kevin A. Bush, Oakland, CA (US); Caleb C. Boyd, Menlo Park, CA (US)

(21) Appl. No.: 17/974,499

(22) Filed: Oct. 26, 2022

Related U.S. Application Data
(60) Provisional application No. 63/272,590, filed on Oct. 27, 2021.

(51) Int. Cl. C25B 9/23; C25B 9/63; C25B 11/032; C25B 13/02; C25B 9/65

(52) U.S. Cl. CPC C25B 9/23; C25B 9/63; C25B 11/032; C25B 13/02; C25B 9/65

(57) ABSTRACT

An electrochemical system, an electrochemical stack and a method for carbon dioxide capture and carbon dioxide recovery. The system has a CO₂ capture device where a metal hydroxide base solution reacts with CO₂ to produce carbonates and bicarbonates. The electrochemical stack has one or more electrochemical cells, each with a gas diffusion anode having a hydrogen supply, a cathode spaced from the anode to define an electrolysis region between them for a salt solution, a cation exchange membrane in the electrolysis region next to the cathode and a metal hydroxide region separated from the electrolysis region by the cathode.

A voltage potential between the anode and cathode produces an acid solution in the electrolysis region, conditions the metal hydroxide base solution in the metal hydroxide region and evolves hydrogen at the cathode. A CO₂ evolution device uses the acid and the carbonates and/or bicarbonates to recover CO₂ and to recover the salt solution for reuse in the electrochemical stack.

### CROSS-REFERENCE TO RELATED APPLICATIONS

This application claims priority from U.S. Provisional Patent Application No. 63/272,590 filed on Oct. 27, 2021 and which is incorporated herein by reference for all purposes in its entirety.

### FIELD OF THE INVENTION

The present invention relates generally to carbon dioxide capture and regeneration systems and methods in which carbon dioxide is captured from dilute sources such as ambient air or from flue gas streams using an aqueous capture solution and in which the carbon dioxide and the aqueous capture solution are regenerated electrochemically.

### BACKGROUND OF THE INVENTION

There is a growing understanding that in order to mitigate the adverse effects of climate change we must not only stop emitting carbon dioxide into the atmosphere, but that we must also extract it from the atmosphere. Extraction should reduce carbon dioxide levels to pre-industrial levels of around 300-350 parts per million (ppm). If this is to be done on an industrial scale, the solution must be incredibly low-cost, both from a capital and operational expenditure perspective.

Aqueous or solvent based carbon dioxide capture systems are simple in that a fluid can be more easily transported. However, they incur energy efficiency penalties if drying is necessary to extract the carbon dioxide that was captured. On the other hand, non-aqueous solvent-based capture systems can face problems of solvent degradation and high cost.

It is well known that carbon dioxide (CO₂) in the gas phase can interact and dissolve into aqueous solutions by forming carbonate and bicarbonate, depending on the pH of the solution. In most CO₂ capture systems, chemical capture solutions with strong CO₂-binding affinities are employed to provide a thermodynamic driving force for capturing gaseous CO₂ from dilute sources, as is the case with ambient air. Many inorganic metal oxides and hydroxides are suitable for such chemical capture solutions. These include oxides and hydroxides of divalent metals (MgO, Mg(OH)₂, CaO, Ca(OH)₂, FeO, Fe₂O₃ and Fe(OH)₂) and monovalent alkali metals (Li₂O, LiOH, Na₂O, NaOH, K₂O, KOH).

In 1999 Klaus Lackner proposed using pools of calcium hydroxide solution to capture CO₂ and form calcium carbonate (CaCO₃) as described in K. Lackner, H. Ziock and P. Grimes, “Carbon Dioxide Extraction From Air: Is It An Option?”, 24th Annual Technical Conference on Coal Utilization & Fuel System, 1999. The process could be reversed by calcination (thermal treatment without melting under a restricted amount of oxygen) of the calcium carbonate to drive off CO₂ and form calcium oxide (CaO).

The calcium oxide was then slaked via hydration to form calcium hydroxide (Ca(OH)₂) and start the process all over again.

While both calcium oxide (CaO) and magnesium oxide (MgO) are attractive options for CO₂ capture due to their abundance, the strong binding energy with CO₂ makes the process difficult to reverse. It requires high calcination temperatures that range between 600-900° C. Such high calcination temperatures make it difficult to use intermittent renewable electricity. That is because for calcination at high temperature it is preferable to maintain a constant high temperature environment rather than cycling the reactor or calciner kiln between low and high temperature. Specifically, cycling can cause wear on kiln materials.

Electrochemical CO₂ regeneration approaches are attractive as they can potentially directly leverage very low-cost electricity from intermittent renewables like wind and solar and operate at near-ambient temperatures. More specifically, electrochemical generation of acid and base is a promising method for leveraging intermittent renewable electricity for economical capture and regeneration of CO₂. Direct electrochemical approaches to transfer between CO₂ and carbonates and/or bicarbonates (CO₃⁻² and HCO₃⁻) as a means of CO₂ regeneration is well studied. These approaches include acid-base swings using electrolysis, bipolar membrane electrodialysis, reversible redox reactions and capacitive deionization. For a summary of this subject the reader is referred to R. Sharifian et al., “Electrochemical carbon dioxide capture to close the carbon cycle”, Energy & Environmental Science, 14, 2021, pgs. 781-814.

However, these regeneration processes suffer from low energy efficiency. In addition, the process of directly creating and capturing a gas such as CO₂ from a liquid electrolyte is complex, due to the need to optimize CO₂ dissolution kinetics and thermodynamics. In cases where O₂, H₂ or other gases are produced, these product gases need to be further separated downstream in expensive processing steps such as pressure swing absorption. These processes also either need to include water splitting at 1.23 V potential, which imposes a heavy energy penalty, or compete with either oxygen evolution or hydrogen evolution at either side of the hydrolysis cell.

As opposed to direct electrochemical CO₂ regeneration, one can perform indirect electrochemical regeneration to create an acid and base that are then used to react with the CO₂-rich solution to release CO₂ and regenerate the CO₂ capture solution. The prior art presents two primary processes to achieve the goal of efficient electrochemical generation of acid and base—the chlor-alkali process and electrodialysis.

The chlor-alkali process has been presented previously for the capture of CO₂. It is an industrial scale process used to produce sodium hydroxide (NaOH) or potassium hydroxide (KOH), chlorine gas (Cl) and hydrochloric acid (HCl). The process involves the electrolysis of sodium chloride (NaCl) or potassium chloride (KCl) solutions to produce chlorine gas and sodium or potassium hydroxide (NaOH or KOH). Hydrogen gas is also generated at the cathode. Hydrogen gas and chlorine gas can be combined to produce high concentration and high purity hydrochloric acid (HCl). However, this cogeneration makes this process energy intensive for carbon capture applications which must be low cost.

U.S. Pat. No. 9,205,375 to Jones et al. describes forming hydrochloric acid (HCl) from this process by dissolving the chlorine gas in water to produce hypochlorous acid (HClO, HOCl, or ClHO) and then catalyzing the decomposition of hypochlorous acid to hydrochloric acid and oxygen in order to be able to utilize the energy of the hydrogen gas separately.

This process is still highly energy intensive. Additionally, the generation of chlorine gas is problematic as it can corrode reactor materials and sealants.

In order to minimize the generation of hydrogen and chlorine gas and decrease the required energy input, bipolar membrane electrodialysis (BPMED) is being explored. In a BPMED system, an external voltage aids the dissociation of water into hydroxyl (OH⁻ anion) and hydronium ions (H₃O⁺ cation). This pH differential can either be used directly or indirectly to control the carbonation and decarbonation of a solution, as described in U.S. Pat. No. 8,205,375 to Littau et al. BPMED has yet to be scaled up economically to capture CO₂ as low current densities and efficiencies hinder the economic viability of BPMED. Higher current densities can rip apart the anion and cation exchange membrane in the BPM. Additionally, several other problems persist such as an inability to be cycled on and off, trouble with CO₂ evolution in the system, damage to the membranes from the introduction of divalent cations, and high overpotentials necessary to drive dissociation at high current densities >100 mA/cm².

It would be desirable to have an electrochemical process that can operate at high current densities, cycle on and off with intermittent renewable power from wind and solar, and be highly efficient in order to enable low-cost capture of carbon dioxide.

### OBJECTS AND ADVANTAGES

It is an object of the invention to provide a novel electrochemical system and method for carbon dioxide capture and regeneration that overcomes many of the challenges described in the prior art. Specifically, it is an object of the invention to provide for an electrochemical process which can operate at high current densities, cycle on and off with intermittent renewable power from wind and solar, and be highly efficient in order to enable low-cost capture of carbon dioxide.

### SUMMARY OF THE INVENTION

The objects and advantages of the invention are provided for by an electrochemical system, an electrochemical stack and by a method for both a carbon dioxide capture step or process and a carbon dioxide recovery step or process. The electrochemical system has a carbon dioxide capture device that uses an aqueous capture solution which is predominantly composed of a metal hydroxide base solution in water. The capture device that contains the aqueous capture solution can be a pool, an exposed container/vessel, one or more troughs or still another device that exposes the aqueous capture solution to capture CO₂ from either a flue stream or ambient air. The metal hydroxide base solution in water reacts with carbon dioxide to produce carbonates and bicarbonates during the carbon capture process.

The electrochemical system uses the electrochemical stack which has one or more electrochemical cells. An electrochemical cell has a gas diffusion anode with a hydrogen supply and a cathode that is spaced with respect to the gas diffusion anode so as to define an electrolysis region for a salt solution between the anode and cathode. The electrochemical cell also has a cation exchange membrane in the electrolysis region placed next to the cathode. Further, the electrochemical cell has a metal hydroxide region separated from the electrolysis region by the cathode. A voltage supply is provided between the anode and the cathode. The voltage supply is used to establish or apply a voltage potential between the gas diffusion anode and the cathode of the electrochemical cell.

Application of the voltage potential causes production of an acid solution at a low concentration in the electrolysis region that contains the salt solution. The voltage potential also conditions the metal hydroxide base solution in water within the metal hydroxide region of the electrochemical cell. In addition, the voltage potential causes production, commonly referred to in the art as evolution of hydrogen at the cathode. Advantageously, a hydrogen recirculation connection is provided to recirculate or feed the hydrogen evolved at the cathode to the hydrogen supply of the gas diffusion anode.

The electrochemical system is further equipped with a carbon dioxide evolution device for performing the carbon dioxide recovery process or step. In addition, the carbon dioxide evolution device performs a salt recovery process or step during which the salt solution that is used in the electrochemical stack, and more precisely in the one or more electrochemical cells, is recovered as well. The carbon dioxide recovery and the salt recovery occur together when the acid solution obtained from the electrochemical stack reacts with the carbonates and bicarbonates obtained from the carbon dioxide capture device. The electrochemical system provides a connection for recirculating the salt solution thus recovered in the carbon dioxide evolution device to the electrochemical stack.

The electrochemical system admits many embodiments of not only its parts but also of the chemical components used in it.

In some embodiments the salt solution used in the electrolysis region is a metal chloride. Suitable metal chlorides are mostly either sodium chloride (NaCl) or potassium chloride (KCl), but can also include calcium chloride (CaCl₂), magnesium chloride (MgCl₂) and any other solution of chloride salts or mixtures thereof. In these embodiments the acid solution is hydrochloric acid (HCl).

In some embodiments the salt solution used in the electrolysis region is a metal nitrite. Suitable metal nitrates are mostly either sodium nitrate (NaNO₃) or potassium nitrate (KNO₃) but can include others or mixtures thereof. In these embodiments the acid solution is nitric acid (HNO₃).

In some embodiments the metal hydroxide base solution is mostly one of the family of metal hydroxide bases or mixtures thereof. These are sodium hydroxide (NaOH), lithium hydroxide (LiOH), calcium hydroxide (Ca(OH)₂), magnesium hydroxide (Mg(OH)₂), potassium hydroxide (KOH) and other metal hydroxides or mixtures thereof.

The acid solution used in the electrochemical system is not very strong. For example, an acid pH of the acid solution that is obtained in the electrolysis region of the electrochemical cell is greater than 0.3. In some embodiments the acid pH is even greater than 2. These values are clearly much higher than obtained in typical industrial acid production. Meanwhile, a base pH of the metal hydroxide base solution is preferably greater than 10.

One of the advantages of the electrochemical system is that it can be broken up into parts that operate independently and at different times. In particular, the carbon dioxide capture device, the electrochemical stack and the carbon dioxide evolution device can each be spatially separated from the others. These parts can also be operated independently without close regard to current status. In other words, they can perform their functions at different times without the need to carefully synchronize the electrochemical system.

The electrochemical system can be used for carbon dioxide capture from either ambient air or from carbon dioxide entrained within a combustion flue or other high concentration source. The carbon dioxide capture device is designed to interact appropriately with either carbon dioxide in ambient air or in the combustion flue. When performing carbon dioxide capture from ambient air the carbon dioxide capture device preferably uses pools or troughs that have porous media placed in them to improve capture performance. Suitable porous media permit the metal hydroxide base solution to be deposited on or over it in a manner that increases an interfacial area between the aqueous capture solution and ambient air. Examples of suitable porous media are rocks, pebbles and sand.

The carbon dioxide evolution device used by the electrochemical system can be provided with various additional equipment to improve performance. In some embodiments the carbon dioxide evolution device has a pressure vessel in order for carbon dioxide recovery to proceed under pressurized conditions. Such conditions yield a pressurized stream of carbon dioxide as output. This form of output is desirable in a number of downstream uses of the recovered carbon dioxide.

The electrochemical cell or cells deployed in the electrochemical stack can also be implemented in various configurations. In some embodiments a separation or gap between the gas diffusion anode and the cation exchange membrane is controlled. For example, the gap between the gas diffusion anode and the cation exchange membrane is maintained at less than 5 millimeters, and in some embodiments at less than 1 millimeter. This small and controlled gap is especially important when the electrochemical stack has many electrochemical cells. Furthermore, when the electrochemical stack has two or more electrochemical cells connected in series or serially within the electrochemical stack it is advantageous to provide a spacer between the gas diffusion anode and the cathode. This allows for hydrogen gas evolution at the cathode and hydrogen gas consumption at the gas diffusion anode. The spacer can be electrically conductive to electrically connect the cathode and the gas diffusion anode.

The method for carbon dioxide capture and carbon dioxide recovery provides for capturing carbon dioxide in the carbon dioxide capture device that uses an aqueous capture solution composed mostly of a metal hydroxide base solution in water. This base solution reacts with carbon dioxide to produce carbonates and bicarbonates and thereby perform the desired carbon dioxide capture. The method uses the electrochemical stack of one or more electrochemical cells. A key step in the method involves applying the voltage between the gas diffusion anode and the cathode to support the three important processes. Namely, producing the acid solution from the salt solution in the electrolysis region, conditioning the metal hydroxide base solution present in the metal hydroxide region, and evolving hydrogen at the cathode.

The method further extends to performing the carbon dioxide recovery and salt recovery in the carbon dioxide evolution device. This is accomplished by reacting the acid solution from the electrochemical stack with the carbonates and bicarbonates obtained from the carbon dioxide capture device. Additionally, the salt solution obtained during salt recovery is recirculated to the electrochemical stack.

The method also admits of many embodiments. For example, it further involves recirculating hydrogen evolved at the cathode to the gas supply for the gas diffusion anode.

The method of invention is complementary with renewable energy sources that may only operate at certain times (e.g., solar energy sources) or under certain conditions (e.g., wind energy sources). In these cases the voltage supply is connected to draw on such intermittent sources of renewable energy.

In some embodiments of the method the acid solution produced in the electrochemical stack is first stored in an appropriate storage container or facility. From there, the acid solution can be injected continuously into the carbon dioxide evolution device to achieve a mostly continuous supply of carbon dioxide in the carbon dioxide recovery process.

In embodiments where the method is performed with a carbon dioxide capture device that has one or more pools or troughs filled with the aqueous capture solution the capture device can be periodically water-flushed. This is particularly applicable when carbon dioxide capture is from ambient air and may extend over significant periods of time (e.g., a number of days). When the one or more pools or troughs are water-flushed following a period of carbon dioxide capture a water-flushed aqueous capture solution is obtained. This solution is preferably stored prior to being fed to the carbon dioxide evolution device.

The present invention, including the preferred embodiment, will now be described in detail in the below detailed description with reference to the attached drawing figures.

BRIEF DESCRIPTION OF THE DRAWING FIGURES

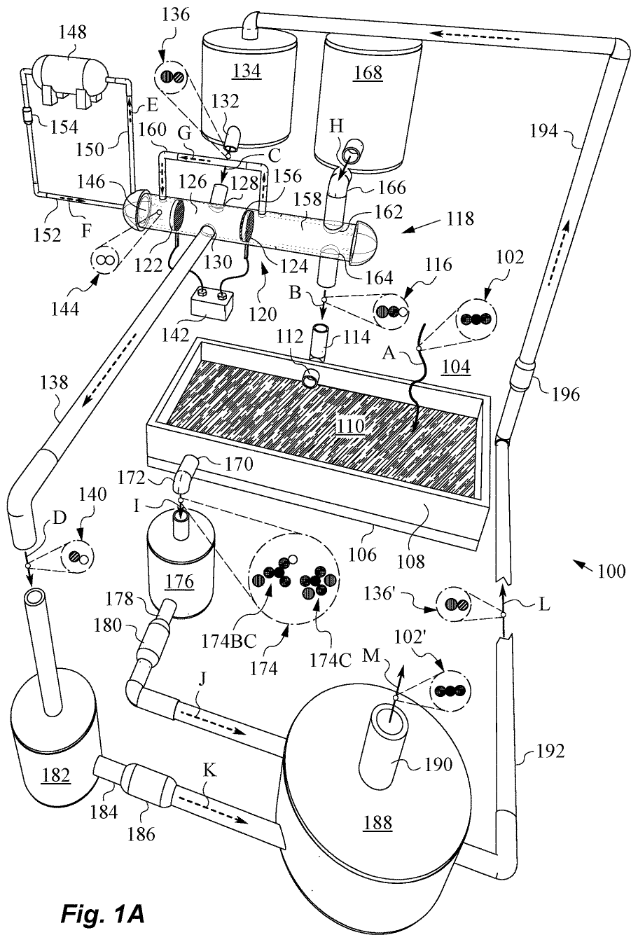

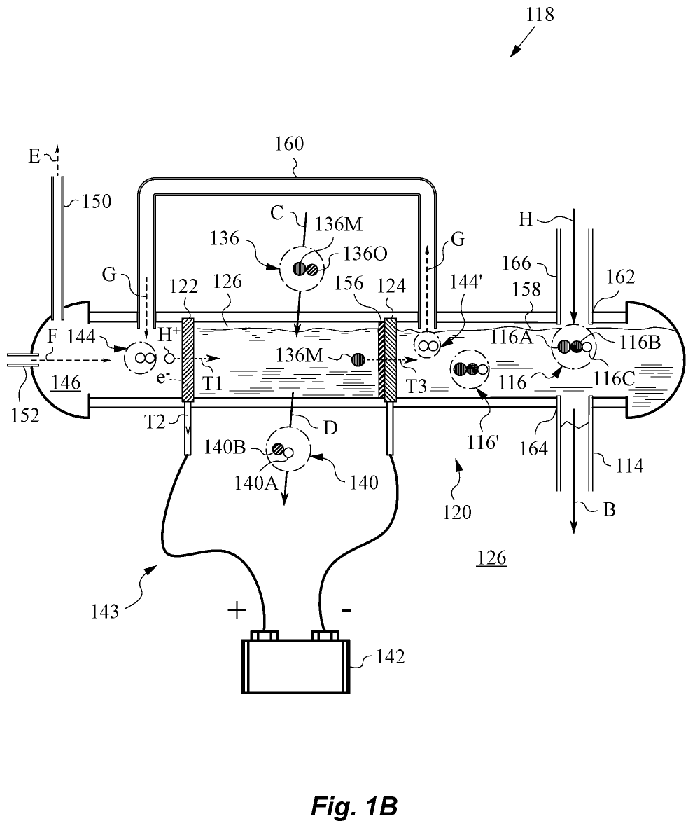

FIG. 1A is a three-dimensional diagram of an electrochemical system according to the invention.

FIG. 1B is a cross-sectional side view diagram of an electrochemical stack having a single electrochemical cell as found in the electrochemical system of FIG. 1A.

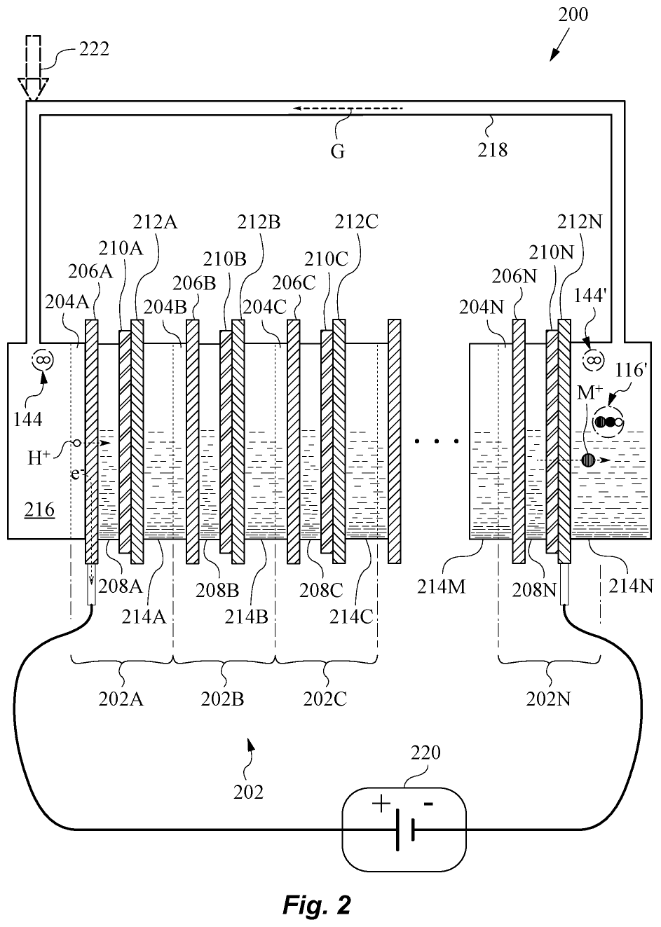

FIG. 2 is a diagram showing another embodiment of an electrochemical stack with a large number of electrochemical cells.

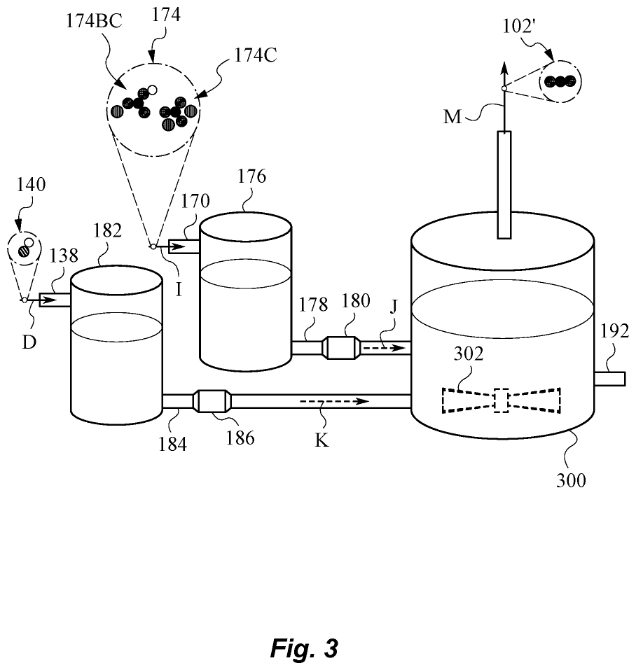

FIG. 3 is a diagram showing an alternative carbon dioxide evolution device.

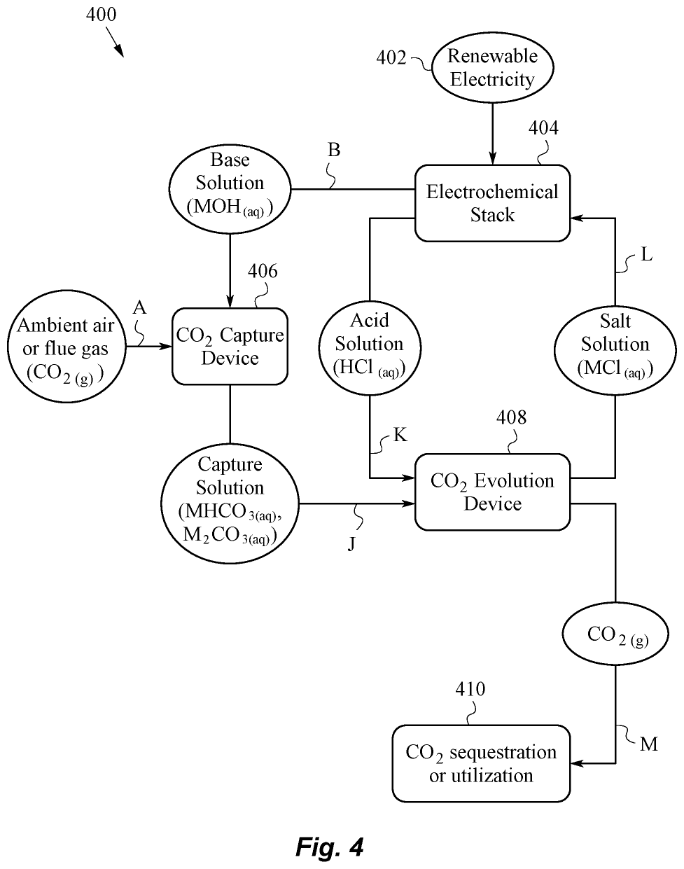

FIG. 4 is a flow diagram summarizing the method of the invention.

### DETAILED DESCRIPTION

The figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention, examples of which are illustrated in the accompanying figures. It is noted that wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

FIG. 1A is a three-dimensional diagram illustrating an electrochemical system 100 according to the invention designed for carbon dioxide capture. In the present example, system 100 is configured for capture of carbon dioxide 102 from ambient air 104. For reasons of clarity and to better explain the invention, FIG. 1A uses vastly enlarged and simplified schematic representations to visualize important chemical components in electrochemical system 100. According to this convention, a single molecule of CO₂ or carbon dioxide 102 present in ambient air 104 is shown as it moves along a path indicated by arrow A.

Electrochemical system 100 has a carbon dioxide capture device 106 that is exposed to ambient air 104. Capture device 106 has a trough 108 filled with an aqueous capture solution 110. Capture device 106 has an inlet 112 leading into trough 108 for admitting aqueous capture solution 110. As schematically indicated in a cut-away section of a pipe 114 that terminates with inlet 112, aqueous capture solution 110 flows through pipe 114 along a flow designated by arrow B. Capture solution 110 contains a metal hydroxide base 116 indicated schematically in the vastly enlarged schematic view adopted herein for clarity. In fact, aqueous capture solution 110 is composed predominantly of metal hydroxide base solution 116 in water (not expressly shown) with a base pH value of 10 or more at a time of admission into trough 108 of capture device 106 at inlet 112.

Aqueous capture solution 110 of metal hydroxide base 116 is exposed to ambient air 104. Thus, carbon dioxide 102 in ambient air 104 can enter aqueous solution 110. This process is visualized with the example of CO₂ molecule 102 moving along the path indicated by arrow A to the surface of aqueous solution 110, where it is trapped and dissolves in the water of aqueous capture solution 110. The basic pH of aqueous capture solution 110 aids in dissolution of CO₂ and promotes formation of carbonic species such as carbonates and bicarbonates. The actual carbon dioxide capture process and production of carbonates and bicarbonates is described in the section addressing operation of electrochemical system 100 further below.

Electrochemical system 100 has an electrochemical stack 118. In the present embodiment, electrochemical stack 118 has just one electrochemical cell 120, but two or more such electrochemical cells can be used. Electrochemical cell 120 has a gas diffusion anode 122 and a cathode 124 that is spaced away from it to produce or define a space or region between them. This space between anode 122 and cathode 124 will be referred to as an electrolysis region 126.

An inlet 128 to electrolysis region 126 and an outlet 130 from electrolysis region 126 are provided. Inlet 128 is connected by a pipe 132 to a supply 134 of a salt solution 136 that is to be admitted into electrolysis region 126. A cut-away portion of pipe 132 visualizes a flow C of salt solution 136 into electrolysis region 126 through inlet 128. A pump (not shown) is typically provided for regulating and maintaining flow C. Outlet 130 connects to a pipe 138 that is designed to guide a flow D of an acid solution 140 shown schematically in a cut-away portion of pipe 138. A pump (not shown) is typically provided for managing flow D of acid solution 140.

A voltage supply 142 is connected between anode 122 and cathode 124. Voltage supply 142 is designed to establish or apply a voltage potential between anode 122 and cathode 124 during operation. Note that acid solution 140 is produced in electrolysis region 126 of electrochemical cell 120 from salt solution 136 under application of the voltage potential as described below in the section addressing operation of electrochemical system 100.

Gas diffusion anode 122 has a hydrogen supply 144. In the present embodiment an enlarged schematic view shows a single molecule of hydrogen H₂ in hydrogen supply 144 for clarity. Hydrogen 144 is maintained in a chamber or region 146 separated from electrolysis region 126 by gas diffusion anode 122 itself. Gas diffusion anode 122 is designed to support a hydrogen oxidation reaction that produces hydrogen ions H⁺ and liberates electrons e⁻ from hydrogen 144 while the voltage potential is applied with the aid of voltage supply 142. To accomplish that, anode 122 either has a catalyst coated gas diffusion layer (GDL) or is a gas diffusion electrode (GDE). The catalyst in GDL or GDE embodiments of anode 122 is typically composed of platinum group metals, but many new catalyst alternatives that are lower cost will be familiar to those skilled in the art. Furthermore, the gas diffusion layer itself is preferably a carbon cloth, carbon paper or graphite felt that is loaded with the catalyst. Other metal meshes can also be used, such as titanium, copper and nickel meshes. An additional cation exchange membrane (not shown) such as Nafion can be used on this side to allow hydrogen ions H⁺ to pass through to electrolysis region 126 and prevent any solution from electrolysis region 126 on the other side of gas diffusion anode 122 from entering region 146.

To maintain the right amount of hydrogen 144 at gas diffusion anode 122 an additional tank 148 of hydrogen 144 is connected to chamber 146. Specifically, an outlet pipe 150 is provided for withdrawing excess hydrogen 144 from chamber 146 and into tank 148. This corresponds to an outflow indicated by arrow E. An input pipe 152 is provided for supplying chamber 146 with hydrogen 144 from tank 148. This corresponds to an inflow indicated by arrow F. A supply pump 154 is mounted on supply pipe 152 to regulate inflow F of hydrogen 144 drawn from tank 148 and delivered to chamber 146.

Electrochemical cell 120 has a cation exchange membrane 156 positioned right next to cathode 124. Cation exchange membrane 156 is inside electrolysis region 126 and serves two main purposes. First, cation exchange membrane 156 is to permit passage to cathode 124 of positively charged metal cations from salt solution 136. Second, cation exchange membrane 156 is to prevent negatively charged hydroxide ions OH⁻ produced at cathode 124 from entering salt solution 136 in electrolysis region 126. It should be noted that the voltage potential between anode 122 and cathode 124 cannot be too high during operation. The operational details addressing this issue and other operational aspects are found below in the section about operation of electrochemical system 100.

Electrochemical cell 120 has a metal hydroxide region 158 that is separated from electrolysis region 126 by cathode 124. Cathode 124 supports production or evolution of hydrogen H₂ while voltage potential is applied with the aid of voltage supply 142. Advantageously, a hydrogen recirculation connection 160 is provided to recirculate or feed hydrogen H₂ evolved at cathode 124 to hydrogen supply 144 in chamber 146. A recirculation flow through connection 160 is indicated in FIG. 1A by arrow G. The additional hydrogen supply 144 recovered at cathode 124 is helpful in ensuring that gas diffusion anode 122 is well supplied.

Metal hydroxide region 158 has an inlet 162 and an outlet 164. Inlet 162 is connected by a pipe 166 to a supply 168 of metal hydroxide base 116. It should be noted that supply 168 can be replenished with metal hydroxide base solution 116 that is siphoned from outlet 164 and combined with additional water prior to re-entering through inlet 162, thereby creating a steady-state flow of more dilute metal hydroxide base solution 116 at inlet 162 and more concentrated base solution 116 at outlet 164. A cut-away portion of pipe 166 visualizes a flow indicated by arrow H of metal hydroxide base 116 into metal hydroxide region 158 through inlet 162. A pump (not shown) is typically provided for regulating and maintaining flow H. Meanwhile, outlet 164 connects to previously described pipe 114 that guides flow B of metal hydroxide base 116 and terminates at inlet 112 to capture device 106.

An outlet 170 from carbon dioxide capture device 106 is connected to a pipe 172 for guiding away a flow indicated by arrow I of products from the carbon dioxide capture process taking place in aqueous capture solution 110 inside trough 108. More precisely, the products of the carbon dioxide capture process are carbonates and bicarbonates 174 as metal hydroxide base solution 116 in water reacts with carbon dioxide 102 in ambient air 104. Flow I of carbonates and bicarbonates 174 is shown schematically in a cut-away portion of pipe 172. The exact type of carbonates and bicarbonates 174 obtained in carbon dioxide capture depends on the chemical components used in electrochemical system 100, and specifically on the choice of metal in metal hydroxide base solution 116, as described in more detail below. For illustrative purposes a carbonate 174C and a bicarbonate 174BC (where the metal can be, e.g., sodium (Na)) are indicated in the enlarged schematic portion of flow I in FIG. 1A.

It is advantageous to store carbonates and bicarbonates 174 obtained in the carbon dioxide capture process. For this purpose, pipe 172 is connected to a storage tank 176 to deliver carbonates and bicarbonates 174 to it. Storage tank 176 has a pipe 178 and a pump 180 for managing an outflow J of carbonates and bicarbonates 174 from it.

Similarly, it is advantageous to store acid solution 140 obtained from electrolysis region 126 of electrochemical cell 120 of electrochemical stack 118. For this purpose, pipe 138 is connected to a storage tank 182 for storing acid solution 140. Storage tank 182 has a pipe 184 and a pump 186 for managing an outflow K of acid solution 140 from it.

Electrochemical system 100 is further equipped with a carbon dioxide evolution device 188 for performing a carbon dioxide recovery process or step. Carbon dioxide evolution device 188 is connected to storage tanks 176, 182 through corresponding pipes 178, 184. Thus, carbon dioxide evolution device 188 can be supplied in a controlled manner, thanks to pumps 180, 186, with carbonates and bicarbonates 174 as well as with acid solution 140.

The input of carbonates and bicarbonates 174 together with acid solution 140 into evolution device 188 leads to carbon dioxide recovery. Specifically, evolution device 188 recovers carbon dioxide 102′ shown schematically and indicated with a prime to differentiate it from carbon dioxide 102 that was captured from ambient air 104. Outlet pipe 190 is provided for recovered carbon dioxide 102′ to exit evolution device 188. A flow or stream of recovered carbon dioxide 102′ is indicated with arrow M.

In addition to recovery of carbon dioxide 102′, evolution device 188 also recovers salt. Specifically, evolution device 188 recovers salt solution 136′ indicated with a prime to differentiate it from salt solution 136 initially fed into electrolysis region 126 through pipe 132 from supply 134. An outlet pipe 192 is provided for recovered salt solution 136′ to exit evolution device 188.

It is advantageous to reuse recovered salt solution 136′ in electrochemical system 100. Thus, a connection or recirculation pipe 194 along with a pump 196 are provided for recirculating salt solution 136′ recovered in carbon dioxide evolution device 188 to electrochemical stack 118. More precisely, recirculation pipe 194 is connected to supply 134 of salt solution 136 to deliver a flow shown by arrow L of recovered salt solution 136′ to supply 134.

The operation of electrochemical system 100 is now explained in reference to FIG. 1A and the more detailed cross-sectional side view diagram of electrochemical stack 118 with just one electrochemical cell 120 shown in FIG. 1B. The cross-sectional side view diagram of FIG. 1B omits a number of parts shown in FIG. 1A in order to focus on the principles of electrochemical operation of electrochemical cell 120.

During operation electrochemical cell 120 receives flow C of salt solution 136 from supply 134 (see FIG. 1A). It should be noted that salt solution 136 can either be from an external source or it can be recovered salt solution 136′ from carbon dioxide evolution device 188 (see FIG. 1A). In FIG. 1B the simplified and enlarged schematic view of salt solution 136 shows that its main constituents, leaving out water, are a metal 136M and another constituent 1360. Depending on the embodiment, suitable metal 136M is an alkali metal such as sodium (Na) or potassium (K), but it can also include other monovalent and divalent metals such as lithium (Li), calcium (Ca), magnesium (Mg), metals of other valences, or mixtures of multiple metals. Meanwhile, constituent 1360 can be chlorine (Cl) or nitrate (NO₂) or other suitable salt(s). Thus, in some embodiments salt solution 136 is a metal chloride such as NaCl, CaCl₂, MgCl₂, KCl or mixtures thereof, and in some other embodiments salt solution 136 is a metal nitrite such as sodium nitrate (NaNO₃) or potassium nitrate (KNO₃). In the embodiment of FIG. 1B salt solution 136 is sodium chloride (NaCl) where metal 136M schematically represents the alkali metal Na and constituent 136O schematically represents Cl.

Since, during operation the voltage potential between gas diffusion anode 122 and cathode 124 is applied by voltage source 142 as shown, hydrogen 144 present in chamber 146 undergoes a hydrogen oxidation reaction at anode 122. The oxidation reaction proceeds according to the following equation:

H₂→2H⁺+2e⁻ (1)

This reaction only needs an overpotential of about 50 mV when a platinum group catalyst is used in gas diffusion anode 122. The hydrogen ions H⁺ and the electrons e⁻ produced in the oxidation reaction are illustrated schematically in FIG. 1B.

Since anode 122 is a catalyst coated gas diffusion layer (GDL) or a gas diffusion electrode (GDE) the hydrogen ions H⁺ can pass through it. Specifically, they pass through gas diffusion anode 122 into electrolysis region 126 that contains salt solution 136 in water, i.e., aqueous salt solution 136, as indicated by arrow T1 in FIG. 1B. Meanwhile, electrons e⁻ simply flow through external circuit 143 of voltage supply 142 to cathode 124, as indicated by arrow T2.

The hydrogen ions H⁺ that pass to electrolysis region 126 through gas diffusion anode 122 and enter aqueous salt solution 136 under the influence of the applied voltage potential between anode 122 and cathode 124 become available for an important chemical reaction. In particular, when salt solution 136 experiences the influx of hydrogen ions H⁺ it becomes more acidic. This acidification process is aided by the following equation:

H⁺+MCl→HCl+M⁺ (2)

where M stands for metal 136M (Na in the present example) and Cl is component 1360 of salt 136 (chlorine in the present example, since the chosen salt 136 is NaCl, as indicated above). In other words, in the present specific example Eq. 2 indicates that acid 140 produced in electrolysis region 126 is hydrochloric acid. This is indicated schematically in flow D of low concentration acid 140 withdrawn from electrolysis region 126 via outlet 130 through pipe 138 (see FIG. 1A). In the present example, acid 140 has two acid constituents 140A and 140B, where constituent 140A is hydrogen and constituent 140B is Cl.

It is further convenient to summarize Eq. 1 and Eq. 2 to indicate the proper overall stoichiometry in a single equation as follows:

H₂+2MCl→2HCl+2M⁺+2e⁻ (3)

At this point it is important to note that in an ideal embodiment, hydrochloric acid 140 produced in the manner described by Eq. 3 is kept at a low concentration. In other words, acid solution 140 thus produced in electrochemical cell 120 of electrochemical system 100 is not very strong in order to ensure the concentration of metal ions M⁺ is much higher than hydrogen ions H⁺ as both are capable of passing through cation exchange membrane 156. The applied voltage potential between anode 122 and cathode 124 is low, e.g., about 0.82 V. This voltage is the minimum needed to drive the reaction. That is because standard H₂ evolution reaction at cathode 124 occurs when cathode 124 is at −0.82 V with respect to anode 122 and reduction of hydrogen gas 144 (see Eq. 1) occurs at 0 V. Thus, the net reaction requires a minimum of 0.82 V potential difference to drive and any resistive losses will further increase this required potential.

For example, an acid pH of acid solution 140 that is obtained under the voltage potential of 0.82 V (and any additional potential to account for resistive losses) established between anode 122 and cathode 124 across electrolysis region 126 is typically greater than 0.3. In some embodiments the acid pH is even greater than 2. These acid pH values are clearly much higher than those obtained in typical industrial acid production that produces strong acids. However, such acid pH values are suitable for carbon dioxide recovery in the present invention.

In addition to producing low concentration or rather high acid pH acid solution 140, the voltage potential drives additional processes. These processes occur at cathode 124 that separates electrolysis region 126 from metal hydroxide region 158 of electrochemical cell 120.

Now, hydroxide region 158 is filled with metal hydroxide base 116 delivered to it by flow H through pipe 166 from supply 168 (see FIG. 1A). More precisely, flow H of metal hydroxide base 116 is admitted into metal hydroxide region 158 through inlet 162. In most cases metal hydroxide base 116 solution is mostly composed of one of four bases or mixtures thereof. These are sodium hydroxide (NaOH), lithium hydroxide (LiOH), calcium hydroxide (CaOH) and potassium hydroxide (KOH) or mixtures thereof. In any case, it is preferred to maintain a base pH of metal hydroxide base solution 116 at a value greater than 10.

In the present example, metal hydroxide base 116 is NaOH. Note that metal hydroxide base 116 is chosen because it uses the same alkali metal as does salt 136, namely Na. Thus, acid 140 and base 116 form a conjugate acid and base pair. In other embodiments other alkali metals or mixtures thereof can be used, as indicated above. Components of metal hydroxide base 116 are shown schematically as 116A, 116B and 116C while leaving out water. Metal component 116A is Na, while components 116B, 116C make up the hydroxide group, namely oxygen 116B and hydrogen 116C.

The negative potential applied by voltage source 142 on cathode 124 affects cations of metal 136M liberated from salt 136 during acid production. In particular, in order to maintain electro-neutrality, cations (designated as M⁺ in Eqs. 2 and 3) of metal 136M flow towards cathode 124. Cation exchange membrane 156 positioned next to cathode 124 permits these cations M⁺ of metal 136M to pass through it and to enter hydroxide region 158. The passage of cations of metal 136M is indicated by arrow T3 in FIG. 1B.

Further, the voltage potential causes production, commonly referred to in the art as evolution of hydrogen 144′ at cathode 124. Hydrogen 144′ evolved at cathode 124 is designated with a prime to distinguish it from hydrogen 144 of hydrogen supply in chamber 146. The evolution of hydrogen 144′ is described by the following equation:

2H₂O+2e⁻→H₂+2OH⁻ (4)

Due to the influx of cations M⁺ of alkali metal 136M (in this particular example Na⁺) through cation exchange membrane 156, as described above, this equation can be restated. In fact, put more generally to include any metal cations M⁺ (same designation as in Eqs. 2 and 3) the equation is as follows:

2H₂O+2M⁺+2e⁻→H₂+2MOH (5)

Note that in alternative embodiments metal cation M⁺ can be a monovalent metal cation such as lithium (Li), potassium (K), rubidium (Rb) or cesium (Cs). Divalent or other-valent metal cations or mixtures of metal cations and also be used in alternative embodiments, as discussed below. It is understood by one skilled in the art that the embodiment presented here explicitly for a single monovalent metal cation applies to divalent metal cations or mixtures of metal cations but alters the chemical reaction balances. Eq. 5 thus describes the formation of a metal hydroxide base (MOH) at cathode 124 accompanied by evolution of hydrogen 144′ (in gas phase). Advantageously, hydrogen recirculation connection 160 recirculates hydrogen 144′ evolved at cathode 124 to hydrogen supply 144 in chamber 146. This recirculation flow G is helpful in ensuring that gas diffusion anode 122 is well supplied with hydrogen.

Meanwhile, cation exchange membrane 156 prevents negatively charged hydroxide ions produced at cathode 124 from entering salt solution 136 in electrolysis region 126 (which can also be referred to as acid region). If these hydroxide ions were allowed to pass into salt solution 136, they would neutralize acid 140 being produced in electrolysis region 126.

As is well-known, acidic conditions are more ideal for evolution of hydrogen 144′, as excess hydronium ions H₃O⁺ or hydrogen ions H⁺ in solution can more easily be catalyzed to produce hydrogen gas 144′. However, hydrogen evolution reaction at cathode 124 will occur in basic conditions as well. As this reaction progresses, metal hydroxide base solution 116 will get more basic. Thus, although any metal or electrically conductive material (such as carbon and carbon alloys) which are stable in basic solution 116 can be used as cathode 124, it is preferable to utilize platinum group metals, nickel, and nickel alloys to catalyze hydrogen evolution as they have been developed for alkaline water electrolysis. Raney nickel is an attractive option due to its low cost compared to platinum group metals and low overpotential required to drive hydrogen evolution in basic conditions. Raney nickel is a highly porous form of nickel typically created by the deposition of a nickel alloy such as Ni—Zn or Ni—Al. This deposition can occur via a number of methods such as plasma spray coating or electrodeposition. Following deposition, the Al or Zn is etched away in a base bath, such as an aqueous solution of KOH or NaOH, to form the porous nickel structure. Other metals and metal alloys may be used such as stainless steel, tungsten and molybdenum carbides and sulfides, nickel phosphides, Ni-Cu alloys, and copper alloys.

The voltage potential applied by source 142 also conditions metal hydroxide base solution 116 in water within metal hydroxide region 158 of electrochemical cell 120. In particular, metal cations 136M passing through cation exchange membrane 156 and cathode 124 into metal hydroxide region 158 as indicated by arrow T3 form metal hydroxide 116′. Metal hydroxide 116′ thus formed is distinguished by a prime from metal hydroxide 116 delivered by flow H through inlet 162 into metal hydroxide region 158. The formation of metal hydroxide 116′ at cathode 124 is already captured in Eq. 5 above.

Now, in light of the above, the net equation of electrochemical cell 120 is described by:

MCl+H₂O→HCl+MOH (6)

Thus, Eq. 6 describes the electrolysis of aqueous monovalent metal salt 136 to form hydrochloric acid 140 and its conjugate metal hydroxide base 116′. This reaction is similar to the net equation of the chlor-alkali process shown in Eq. 7 as follows:

2MCl+2H₂O→H₂+Cl₂+2MOH (7)

However, the reaction of Eq. 6 used in the present invention avoids the excess generation of hydrogen H₂ and chlorine Cl₂ gases to advantageously lower the net energy required to drive the electrolysis reaction forward. Divalent or other-valent metal cations can also be used, as discussed below. It is understood by one skilled in the art that the embodiment presented here explicitly for a single monovalent metal cation applies to divalent metal cations or mixtures of metal cations but alters the chemical reaction balances.

The chlor-alkali process described by Eq. 7 is used industrially to generate high purity acid because hydrogen and chlorine gases H₂, Cl₂ can be extracted from an electrolysis cell and reacted to form hydrochloric acid HCl. Similarly, a bipolar membrane electrodialysis (BPMED) cell can also produce high concentration acid and base as anion exchange membranes and cation exchange membranes are employed to separate negatively charged and positively charged hydroxide OH⁻ and hydronium ions H₃O⁺, respectively.

In contrast, electrochemical cell 120 configured and operated as described herein cannot operate with high concentrations of acid 140 because hydrogen ions H⁺ can travel across cation exchange membrane 156 and neutralize base 116′ generated at cathode 124. Thus, solution of salt 136 should be of a high concentration so that the concentration of alkali metal cations 136M, sodium in this particular embodiment, is significantly larger than the concentration of hydrogen ions H. This is done so that, preferably, alkali metal cations 136M flow towards the side of cathode 124 to compensate for charge flow rather than hydrogen ions H. When alkali metal cations 136M pass through cation exchange membrane 156, they charge compensate for hydrogen ions H⁺ generated through hydrogen evolution reaction at cathode 124 and so base 116′ becomes more basic and thus compensates overall base pH of base solution 116 in metal hydroxide region 158. If the concentration of hydrogen ions H⁺ between gas diffusion layer of anode 122 and cation exchange membrane 156 is close to the concentration of alkali metal cations 136M (M⁺ cations), then hydrogen ions H⁺ may pass through cation exchange membrane 156 and neutralize hydroxide ions OH⁻ generated at cathode 124. This situation should be avoided as acid 140 and base 116′ production is desired. Therefore, the concentration of hydrogen ions H⁺ or hydronium ions H₃O⁺ should be at least 10 times, and preferably 100 times lower than the concentration of alkali metal cations 136M. This is advantageous and intended for operating electrochemical cell 120 in accordance with the invention, but is not ideal for the production of high concentration of acid 140, such as HCl, where normal industrial production aims at concentrations that can reach >12M.

When salt 136 is NaCl then its solubility in water at 25° C. is around 6M. When salt 136 is KCl then its solubility in water at 25° C. is around 4.55M. Thus, the maximum practical concentration of hydrogen ions H⁺ is around 0.01M to 0.5M which corresponds to an acid pH of about 0.3 to 2. Note, even a higher acid pH of 3 to 6 is sufficient to drive CO₂ recovery in system 100, as described below. However, at higher acid pH values the concentration of acid 140 is very low and thus a significantly larger volume of acid 140 solution will be required to react with carbonates and bicarbonates 174 (see FIG. 1A). This is undesirable from a water usage perspective. Thus, in some embodiments an acid pH even lower than 0.3 is acceptable when energy loss in electrochemical system 100 is not of high consideration.

Control over process flows or streams of salt 136 and hydroxide 116 is important. In other words, it is important to control flow C of salt solution MCl 136 into electrolysis region 126 as well as flow H of hydroxide base solution MOH 116 into hydroxide region 158. This may be done by pumps or any other flow controllers (not shown). Increasing and/or decreasing the flow rate of process streams or flows C, H can be accomplished by a number of different mechanisms which are well known in the art.

In the present example, when hydroxide solution 116 is NaOH solution then its flow H should be preferably kept at a low rate in order to reach a higher base pH. Specifically, a base pH of 10 is desirable in hydroxide region 158. Meanwhile, when salt solution 136 is NaCl solution its flow C should be kept at a higher rate to minimize the increase in hydrogen ion H⁺ concentration for the reasons described previously. A pump (not shown) for hydrogen H₂ should also be employed to cycle the hydrogen gas H₂ between its generation at cathode 124 and consumption at anode 122. Such recirculation flow G of H₂ has through connection 160 is indicated in FIG. 1A as well as in FIG. 1B. However, a pump may not be necessary if electrochemical cell 120 is held at a slightly elevated pressure above atmospheric. Under these conditions any hydrogen gas H₂ generated at cathode 124 will cycle naturally to the side of anode 122. The pump may still be useful, however, in order to prevent stagnation of H₂ gas.

In order to minimize the overpotential required to drive the reaction forward and also increase the energy efficiency of electrochemical system 100 for the production of acid 140 and base 116′, ohmic losses in electrochemical cell 120 or cells in embodiments where electrochemical stack 118 deploys a number of them should be minimized.

Metal chloride solutions like NaCl and KCl possess high ionic conductivity, which aids in minimizing the resistance in salt solution 136. In an ideal electrochemical stack with many electrochemical cells the width of the salt solution, as measured between the gas diffusion anode and cation exchange membrane should be less than 5 mm and preferably less than 1 mm. Embodiments of such electrochemical stacks with multiple electrochemical cells are described below.

We now return to FIG. 1A to describe the operation of carbon dioxide evolution device 188. Carbon dioxide evolution device 188 is an acid-base reactor akin to ones for reacting baking soda and vinegar. The reaction proceeds to near completion to drive off pure stream M of carbon dioxide 102′ from carbonates and bicarbonates 174 of alkali metal 116A (see FIG. 1B), which in the present case is sodium (Na). We thus have:

NaHCO₃+CH₃COOH→NaCH₂COO+H₂O+CO₂ (8)

where NaHCO₃ is sodium bicarbonate 174BC, CH₃COOH is acetic acid (vinegar) and NaCH₃COO is sodium acetate. Note here that typical vinegar has a pH of about 2.5, corresponding to a hydrogen ion H⁺ concentration of about 0.003M. This demonstrates that high concentration of acid 140, in this case HCl provided from storage tank 182, is not necessary to drive the decarbonization reaction of metal carbonates and bicarbonates 174.

The acid/base reaction that uses acid 140 produced by electrochemical cell 120 proceeds with metal carbonates 174C (M₂CO₃) as follows:

M₂CO₃+2HCl→2MCl+H₂O+CO₂ (9)

Meanwhile, for the acid/base reaction with metal bicarbonates 174BC (MHCO₃) we have:

MHCO₃+HCl→MCl+H₂O+CO₂ (10)

It can be seen from Eq. 9 and Eq. 10 that both metal bicarbonates 174BC and metal carbonates 174C will fully react with acid 140, in this case hydrochloric acid HCl, to drive off gaseous carbon dioxide 102′. In this way, pure stream M of carbon dioxide 102′ is produced and it can be sequestered underground in suitable formations such as saline aquifers, mineralized in rocks such as olivine, serpentine, and basalt, or it can be utilized in enhanced oil recovery. Alternatively pure stream M of carbon dioxide 102′ can be utilized in chemical processes such as ethanol and methanol production or petrochemical production of plastics and olefins.

In many scenarios of utilization or storage carbon dioxide 102′ must be compressed in order to be transported. In a preferred embodiment, carbon dioxide evolution device 188 in which this acid/base decarbonization reaction is done is a pressure vessel where aqueous acid 140 is injected into aqueous carbonate 174C or bicarbonate 174BC solution in order to generate carbon dioxide 102′ at higher pressure. At higher pressures, carbon dioxide 102′ generated according to Eq. 9 or 10 is more soluble in water, similar to a carbonated beverage. But the reaction will still drive forward and higher-pressure stream M of carbon dioxide 102′ will alleviate compression requirements downstream for CO₂ delivery and storage.

One benefit of the proposed invention is that the acid and base produced from electrochemical cell 120 can be stored prior to use. Thus, steps which are preferable to run continuously may run continuously and steps which should run intermittently can run intermittently. For example, electrochemical cell 120 will likely run at below a 70% duty cycle in order to leverage the lowest cost renewable electricity. Acid 140 and base 116 produced by electrochemical cell 120 can be stored until needed for carbonation and decarbonation.

For introduction into a CO₂ pipeline, it may be preferable to operate the purification and compression steps for this process continuously. Acid 140 can be injected in a controlled way continuously into carbonate 174C or bicarbonate 174BC solution to produce a more continuous stream M of carbon dioxide 102′.

Recovered metal salt solution 136′ produced from reactions described by Eqs. 9 and 10 is recycled back into electrochemical cell 120 to undergo electrolysis and restart the cycle. In particular, recovered metal salt solution 136′ exits carbon dioxide evolution device 188 through outlet pipe 192. Further, pump 196 and recirculation pipe 194 return recovered salt solution 136′ to supply 134 that feeds electrochemical cell 120. Now, recovered salt 136′ will likely need to be filtered in order to maintain high performance of electrochemical cell 120. Thus, pump 196 may additionally include a filtering stage for filtering salt solution 136′ before sending it into recirculation pipe 194.

While electrochemical system 100 can potentially be operated as a closed loop, carbon dioxide capture device 106 will likely introduce contaminants. These contaminants will likely be at low enough concentration to not significantly affect the acid/base reaction to drive decarbonation in carbon dioxide evolution device 188. Suitable filters (not shown) can be introduced in the carbonation step progressing in carbon dioxide capture device 106 and/or salt solution 136′ can be filtered in outlet pipe 192 and/or in recirculation pipe 194, as mentioned above.

Finally, we turn to the operation of carbon dioxide capture device 106. Carbon dioxide capture proceeds with the reaction of metal base 116 produced by electrochemical cell 120 in hydroxide region 158. During operation, metal base 116 is delivered to trough 108 of carbon dioxide capture device 106 by pipe 114 as flow B admitted through inlet 112. In trough 108 metal base 116 is mixed with water to produce aqueous capture solution 110 that reacts with carbon dioxide 102, which in the present embodiment is present at low concentration in ambient air. In alternative embodiments, carbon dioxide 102 can be captured from sources with higher concentration, such as from a flue gas stream.

In the present embodiment, carbon dioxide 102 is captured into aqueous solution 110 either via direct reaction of carbon dioxide 102 with hydrated metal hydroxide (see Eq. 13 and Eq. 15) or dissolution of gaseous carbon dioxide 102 in water according to:

CO₂+H₂O⇄H₂CO₃ (11)

As the base pH of aqueous solution 110 lowers, carbonic acid H₂CO₃ of Eq. 11 can dissociate into hydrogen ions H⁺ and bicarbonate ions HCO₃⁻ as follows:

H₂CO₃→H⁺+HCO₃ (12)

And as the base pH of aqueous solution 110 lowers further, bicarbonate ions HCO₃⁻ can further dissociate according to Eq. 13 as follows:

HCO₃⁻⇄H⁺+CO² (13)

While metal hydroxide base 116 (MOH) can directly react with carbon dioxide 102 to form metal carbonate 174C (M₂CO₃), metal hydroxides will be hydrated or aqueous in reality because metal hydroxides readily absorb moisture from the air and require significant energy to dehydrate. There would be no practical reason to dehydrate metal hydroxide base 116 since electrochemical cell 120 produces aqueous metal hydroxide base 116. The carbonation reaction of base 116 with carbon dioxide 102 proceeds as follows:

2MOH+CO₂→M₂CO₃+H₂O (14)

As the reaction of Eq. 14 proceeds, basic aqueous capture solution 110 will become less basic, causing base pH to lower. And if the dissolved carbon dioxide 102 is able to reach a high enough concentration, then bicarbonates 174BC are produced as follows:

M₂CO₃+CO₂+H₂O→2MHCO₃ (15)

While metal hydroxide 116 readily absorbs water, metal carbonate can dry out or dehydrate if, for example, it is left in the sun. In order to get to the metal bicarbonate form, a sufficient amount of water and dissolved carbon dioxide 102 must be present at a near neutral pH to drive the reaction described by Eq. 15. If the pH of aqueous solution 110 is too high, above approximately 11, there will only be trace amounts of bicarbonate ions in solution.

It is desirable for efficiency of electrochemical system 100 to drive the carbonation reaction all the way to metal bicarbonate generation described in Eq. 15 because then 1 mol of HCl can evolve 1 mol of carbon dioxide. If only metal carbonate is produced, then 2 mols of HCl are required to evolve 1 mol of CO₂, as seen in Eq. 9, which effectively doubles the electrical energy requirements on electrochemical system 100. It is difficult to drive electrochemical system 100 all the way to the bicarbonate state, but since electrical energy is likely to dominate system cost in most practical implementations, focusing on bicarbonates is worthwhile for system economics.

One of the advantages of electrochemical system 100 is that it can be broken up into parts that operate independently and at different times. In particular, carbon dioxide capture device 106, electrochemical stack 118 with one or more electrochemical cells 120 and carbon dioxide evolution device 188 can each be spatially separated from each other. In fact, this is the arrangement shown in FIG. 1A. Even more importantly, these elements can be operated independently without paying close attention to their current status. In other words, the elements such as device 106, electrochemical cell 120 or multiple electrochemical cells 120 of electrochemical stack 118 and carbon dioxide evolution device 188 can perform their functions at different times without the need to carefully synchronize electrochemical system 100.

The method of invention is complementary with renewable energy sources that may only operate at certain times (e.g., solar energy sources) or under certain conditions (e.g., wind energy sources). When such renewables are used, voltage supply or source 142 can be connected to draw on such intermittent source(s) of renewable energy.

FIG. 2 is a diagram showing another electrochemical stack 200 that is manufactured with a number of electrochemical cells 202 and can be deployed in electrochemical system 100. As remarked above, the use of electrochemical stack 200 with many electrochemical cells 202 is preferred. Of the number N of electrochemical cells 202 the first three cells and the last cell 202A, 202B, 202C, and 202N are expressly referenced for clarity. In addition, parts and elements analogous to those introduced above in FIGS. 1A-1B will be referenced with corresponding reference numbers.

Each one of electrochemical cells 202A, 202B, 202C, through 202N have a hydrogen gas space 204A, 204B, 204C, through 204N defined next to and in the present configuration to the left of their gas diffusion anodes 206A, 206B, 206C, through 206N. Each one of electrochemical cells 202A, 202B, 202C, through 202N has an electrolysis region 208A, 208B, 208C through 208N for metal chloride salt solution 136 (see FIG. 1B), as well as cation exchange membranes 210A, 210B, 210C through 210N next to their cathodes 212A, 212B, 212C through 212N. Electrochemical cells 202A, 202B, 202C, . . . , 202N have metal hydroxide regions 214A, 214B, 214C, . . . , 214N for metal hydroxide base 116 (see FIG. 1B) separated from electrolysis regions 208A, 208B, 208C, . . . , 208N by cation exchange membranes 210A, 210B, 210C, . . . , 210N and cathodes 212A, 212B, 212C, . . . , 212N.

Electrochemical stack 200 has a chamber 216 that contains hydrogen supply 144. For clarity, an enlarged schematic view shows a single molecule of hydrogen H₂ gas in hydrogen supply 144. To maintain the right amount of hydrogen 144, a tank of hydrogen gas (not shown) may be connected to chamber 216 (see FIG. 1A). Further, a hydrogen recirculation connection 218 is provided for recirculating hydrogen 144′ gas evolved at cathode 206N of last electrochemical cell 202N to hydrogen supply 144 in chamber 216. Thus, recirculation flow G is established from the last metal hydroxide region 214N to chamber 216.

Hydrogen gas space 204A of first electrochemical cell 202A actually overlaps with chamber 216. Note that recirculation flow G is thus helpful in ensuring that gas diffusion anode 206A of first electrochemical cell 202A is well supplied with hydrogen. Although hydrogen gas space 204A is generally delimited by a dashed line, it will be understood that this space does not have a specific boundary; it is simply the region from which anode 206A is able to readily draw hydrogen 144 to obtain hydrogen ions H⁺ and electrons e⁻ through hydrogen oxidation reaction (see Eq. 1). Similarly, hydrogen gas spaces 204B, 204C, . . . , 204N overlap with portions of metal hydroxide regions 214A, 214B and 214M of preceding cells.

Electrochemical stack 200 has a voltage source 220 connected to gas diffusion anode 206A of first electrochemical cell 202A and to cathode 212N of last electrochemical cell 202N. Electrochemical cells 202 stacked in the sequence described above form a series, and therefore the voltages across them add. For example, electrochemical stack 200 can be constructed of more than fifty cells 202 and thus a total voltage drop or potential difference from anode 206A to cathode 212N can be in excess of 50 V. Therefore, voltage source 220 should be designed to be able to maintain such DC voltage across electrochemical stack 200 during operation.

Electrochemical cells 202 can be spaced out with an electrically conductive spacer (not shown) to separate out but electrically connect each cathode of a preceding cell to the anode of the subsequent cell in the series. The conductive spacer should be thick enough to provide a sufficient gap between each preceding cathode and subsequent anode to ensure that there is sufficient space, i.e., that hydrogen gas spaces 204B-N are large enough to allow for hydrogen gas to evolve from metal hydroxide base 116 and reach gas diffusion anodes 206B-N without blocking flows H and B (see FIG. 1B) of metal hydroxide base 116 in and out of successive metal hydroxide regions 214A-N.

Electrochemical stack 200 is preferably oriented such that hydrogen gas 144′ that is evolved at each cathode 212A-M in of stack 200 floats upwards through metal hydroxide base solution 116 to reach gas diffusion anode 206B-N of the subsequent cell 202. Floating occurs based on the buoyancy of H₂ gas in a liquid solution. Additionally, it can be advantageous to operate electrochemical stack 200 at elevated temperature in order to decrease the solubility of H₂ gas in the water of metal hydroxide base solution 116. Increasing the system temperature will also increase the ionic conductivities of metal hydroxide base solution 116 and of the metal salt solution 136, leading to lower ohmic losses.

In order to aid in starting up electrochemical stack 200 a supplemental hydrogen gas supply loop 222, here partly indicated in dashed lines with corresponding valve in hydrogen recirculation connection 218, can be added to flow H₂ gas into chamber 216 upon starting up. In some cases, an overpressure of H₂ can be provided in electrochemical stack 200 to aid in reaction kinetics of hydrogen oxidation (see Eq. 1).

In a highly preferred design of electrochemical stack 200 the width of electrolysis regions 208A, 208B, 208C, . . . , 208N as measured between each gas diffusion anode 206A-N and following cation exchange membrane 210A-N is less than 5 mm and preferably even less than 1 mm. However, there will be some technical difficulties in achieving such small separations or gaps between them if the membranes are unsupported. Spacers to separate the membranes that form anodes 206A-N from cation exchange membrane 210A-N can be employed to prevent sagging of the membranes and to keep the membranes straight/planar. These spacers can be electrically conductive so as to also electrically connect cathodes 212A-N and gas diffusion anodes 206A-N.

In some embodiments biaxial tension is applied to membranes forming gas diffusion anodes and cation exchange membranes to prevent sagging. Sagging should be avoided as it will create non-uniformities in the flow fields (see C, D and H, B indicated in FIG. 1B) and also lead to the potential for hot-spot heating. The spacers can be made of a variety of materials such as plastics, metals, or ceramics that do not react with salt solution 136 or acid 140 that is created.

In some embodiments of the method acid solution 140 produced in electrochemical stack 200 is first stored in an appropriate storage container or facility. From there, acid solution 140 can be injected continuously into carbon dioxide evolution device 188 to achieve a mostly continuous supply of carbon dioxide 102′ in the carbon dioxide recovery process.

FIG. 3 shows a carbon dioxide evolution device 300 that can be used in electrochemical system 100 provided with additional equipment to improve performance. Previously introduced elements are designated by the same reference numbers as in the above drawing figures.

Carbon dioxide evolution device 300 is a pressure vessel in order for carbon dioxide recovery to proceed under pressurized conditions. Such conditions yield a pressurized stream M of carbon dioxide 102′ as output. This form of output is desirable in a number of downstream uses of recovered carbon dioxide 102′.

In addition, carbon dioxide evolution device 300 has a stirring mechanism 302. Thus, solution in the CO₂ evolution device 300 can be stirred or mixed at a variably controlled rate to control the rate of reaction and ensure high reaction yield between acid 140 and carbonates 174. Carbon dioxide evolution device 300 is ideally designed for mixing of acid solution 140 and carbonate/bicarbonate solution 174 such that reaction yield and throughput is optimized for minimum cost per ton of captured carbon dioxide 102. Design of mixers, tanks, pipes and other reactor components and geometries to optimize mixing of chemical reactions between two liquids or liquids and solids is well-known in the art. For examples the reader is referred to E. L. Paul, V. A. Atiemo-Obeng and S. M. Kresta, Handbook of Industrial Mixing, John Wiley & Sons, 2003.

FIG. 4 is a process diagram 400 that summarizes the method of the invention. The streams or flows introduced in the above embodiments are referenced in process diagram 400.

The process preferably relies on a renewable electricity supply 402 that provides the voltage required to operate an electrochemical stack 404 according to the principles explained above. Preferably, electrochemical stack 404 is equipped with many electrochemical cells arranged in series and the voltage is applied between the first anode and the last cathode of the stack.

The function of electrochemical stack 404 is to perform electrolysis of an aqueous salt MCl_{(aq)} solution to form a metal hydroxide base solution (MOH_{(aq)} and hydrochloric acid (HCl_{(aq)}). These reactions proceed in accordance with the principles explained above. Metal hydroxide base solution (MOH_{(aq)}) is then delivered in flow B to a CO₂ capture device 406. Hydrochloric acid (HCl_{(aq)} is delivered by flow K to a CO₂ evolution device 408.

CO₂ capture device 406 captures CO₂ either from ambient air of from a more concentrated source like flue gas as indicated by arrow A. As explained above, the CO₂ capture process produces a capture solution with carbonates and bicarbonates (M₂CO_{3(aq)}, MHCO_{2(aq)}). These carbonates and bicarbonates are delivered by flow J to CO₂ evolution device 408.

When supplied with flow K of hydrochloric acid (HCl_{(aq)} and flow J of carbonates and bicarbonates (M₂CO₃_{(aq)}, MHCO₃_{(aq)}) CO₂ evolution device 408 supports the spontaneous and exothermic reaction of hydrochloric acid (HCl_{(aq)}) with carbonates and bicarbonates (M₂CO_{3(aq)}, MHCO_{2(aq)}). This reaction produces aqueous salt MCl_{(aq)} solution as well as a CO₂ gas.

The aqueous salt MCl_{(aq)} solution is returned to electrochemical stack 404 by flow L. Meanwhile, CO₂ gas is delivered to CO₂ sequestration or utilization stage(s) 410 by stream M.

Process diagram 400 of FIG. 4 is a schematic of the CO₂ capture and regeneration process that involves three main steps. The three main steps are (1) aqueous acid and base formation through electrochemical stack 404, (2) CO₂ evolution from reaction between a carbonate/bicarbonate solution and the acid produced from electrochemical stack 404, and (3) the capture of CO₂ by a basic aqueous solution to form carbonates and bicarbonates. These steps are physically separate and can occur on different time scales and at different times (i.e., each step does not need to occur one directly after the other in sequence, but rather can happen at varying time intervals or with time separations between each step depending on ideal conditions for each separate stage).

Now, the carbon capture process in capture device 406 through carbonation reaction between the metal hydroxide (MOH_{(aq)}) and carbon dioxide CO₂ can occur with either ambient air or a flue gas acting as a source of CO₂, as indicated in process diagram 400. Klaus Lackner calculated, using the free energy of mixing, that the theoretical minimum work required to separate CO₂ from ambient air with a CO₂ concentration of approximately 400 ppm is −20 kJ/mol-CO₂. In comparison, the theoretical minimum work required to capture CO₂ from a CO₂-rich flue gas stream is −8 kJ/mol-CO₂. Thus, despite an approximately 250X difference in CO₂ concentration between ambient air and a combustion flue gas, the minimum energy requirement does not change significantly due to the logarithmic dependence of mixing energy on CO₂ partial pressure.

In a preferred embodiment, the system of invention is used to capture CO₂ directly from the air, also referred to as direct air capture (DAC). Both sodium hydroxide (NaOH) and potassium hydroxide (KOH) have sufficient driving force for the reaction with ambient concentrations of CO₂ at >80 kJ/mol-CO₂. Both NaOH or KOH are stronger bases than monoethanolamine (MEA) or other amines such as diethanolamine (DEA) and methyldiethanolamine (MDEA), making the alkali hydroxides better suited for ambient direct air capture, where the CO₂ concentration is much lower than in flue gases, where MEA is preferentially used due to its low energy to regenerate (lower binding energy of CO₂). The lower energy requirement of the electrochemical cell described in this invention may offset the higher energy to regenerate the CO₂ capture solution in comparison to amine sorbents, so the possibility of using this method in flue gas CO₂ capture is still applicable.

Active contactors can be used to increase the rate at which CO₂ is reacted with a hydroxide solution, but these systems increase the capital expenditure (CAPEX) and energy consumption dramatically. Keith et al. at Carbon Engineering use actively pumped contactors or active scrubbers. U.S. Pat. No. 9,095,813 to Keith et al. describes an active scrubber that is effective for scrubbing CO₂ from the air using aqueous KOH or NaOH but is energy and CAPEX intensive, as described in Keith et al., “A Process for Capturing CO₂ from the Atmosphere”, Joule, 2, 2018, pp. 1573-1594. This is because large fans and contacting structures must be erected to contact CO₂.

In a preferred embodiment, the method of contacting ambient air with the metal hydroxide MOH is done in an ambient weathering passive air contactor, where MOH is carbonated by ambient air without significant pumping of the metal hydroxide solution MOH_{(aq)}. Ambient weathering passive contactors have been proposed previously for Mg(OH) or Ca(OH) to carbonate formation, such as in the paper N. McQueen et al,, “Ambient Weathering of Magnesium Oxide for CO₂ Removal from Air”, Nat. Comm., 2020, 11, pg. 3299. The process proposed by N. McQueen et al. suffers from high regeneration energy required to regenerate MgCO₃ and CaCO₃ to MgO and CaO, which is typically done in calcining kilns at temperatures exceeding 600° C. The usage of solid rocks rather than aqueous solutions makes it more labor intensive to transport the carbonate. Magnesium hydroxide and calcium hydroxide also suffer from slow reaction kinetics and can take up to a year to form carbonates in ambient air, as opposed to sodium hydroxides and potassium hydroxides in aqueous solution, which can be substantially carbonated in hours.

In another embodiment of the invention, the MOH_{(aq)} solution is pumped, poured, sprayed, or otherwise deposited into large troughs or pools. In this scenario, a very high concentration of MOH in water is preferred to speed up the reaction. If left completely stagnant at high concentration (e.g., >1M), the pools or troughs will form a layer of metal carbonate on the top surface, thus minimizing the interaction of CO₂ with the underlying basic solution and limiting the overall reaction. This top surface layer of carbonate forms because most metal carbonates such as sodium carbonate and potassium carbonate are less soluble in water than sodium hydroxide or potassium hydroxide by at least a factor of 3, causing carbonate crystals to form on the top surface. Thus, the troughs or pools are preferably gently agitated in order to break up this top surface layer and allow the continued reaction of the basic solution with ambient CO₂.

In still another embodiment, the pools or troughs are co-located on solar and/or wind farms to decrease land cost and directly utilize the energy produced in order to avoid the need for grid interconnection. In a specific example of this embodiment, bifacial solar panels are used in order to benefit from the increased albedo from the white metal carbonates. Beneficially, the carbonates and bicarbonates formed are still very soluble in water, enabling them to be dissolved and flowed or pumped into a storage tank to await the decarbonation acid/base reaction. Since the rate of reaction with ambient levels of CO₂ in a largely passive system will be slow, the depth of the pools or troughs or MOH solution should be fairly shallow, such as less than 1 cm.

Pebbles or sand can be added to the trough in order to increase the surface area of the liquid/air interface. In a preferred embodiment, the metal hydroxide solution is slowly passed over a trough with 1-10 mm sized rocks such that the rocks protrude above the solution level, but the tops of the rocks are wetted by the MOH solution. In this way, the liquid/air interfacial area is increased, thus increasing the rate of reaction with CO₂ to form carbonates.

In another advantageous embodiment, the contactor pools are located in a cold climate or a desert with large temperature fluctuations because

CO₂ is more soluble in colder water than warmer water. The increased solubility of CO₂ will help drive the carbonation reaction and specifically is necessary to create metal bicarbonates based on Eq. 15.

In embodiments where the method is performed with a carbon dioxide capture device that has one or more pools or troughs filled with the aqueous capture solution the capture device can be periodically water-flushed. This is particularly applicable when carbon dioxide capture is from ambient air and may extend over significant periods of time (e.g., a number of days). When the one or more pools or troughs are water-flushed following a period of carbon dioxide capture a water-flushed aqueous capture solution obtains. This solution is preferably stored prior to being fed to the carbon dioxide evolution device.

The above discussion describes the usage of monovalent cations such as Na⁺, K⁺ and Li⁺, but divalent cations such as Ca²⁺ and Mg²⁺ or mixtures of divalent cations can also be employed using the same electrochemical system. In the electrochemical cell the processes described by Eq. 1 and Eq. 4 still occur at the anode and cathode, respectively. But in the case of divalent cation, Eq. 2 and Eq. 3 will change to the following at the anode:

2H⁺+MCl₂→2HCl+M²⁺ (2b )

H₂+MCl₂→2HCl+M²⁺+2e⁻ (3b)

Meanwhile, at the cathode, Eq. 5 will change to:

2H₂O+M²⁺+2e⁻→H₂+M(OH)₂ (5b)

Therefore, the net reaction of the electrochemical cell is summarized by:

MCl₂₋+2H₂O→2HCl+M(OH)₂ (6b)

The reaction between the divalent metal carbonate and acid becomes:

MCO₃+2HCl→MCl₂+H₂O+CO₂ (9b)

And the reaction of the divalent metal hydroxide with CO₂ becomes:

M(OH)₂+CO₂→MCO₃+H₂O (14b)

The total system describes the electrolysis of alkali chloride salts, such as for the sodium system, such that the overall reactions can be described by the following equations for the main stages. For sodium chloride (NaCl) electrolysis:

NaCl 30 H₂O→HCl+NaOH (16)

For CO₂ capture:

2NaOH+CO₂→Na₂CO₃+H₂O (17)

For CO₂ evolution:

2NaOH+CO₂→Na₂CO₃+H₂O (18)

This system is preferred due to the abundance and low cost of sodium chloride (NaCl) and potassium chloride salts. However, alternative acid/base systems can also be considered with the same electrochemical cell(s), CO₂ capture and CO₂ recovery systems. For example, nitric acid can be produced via electrolysis of sodium nitrate, hypochlorous acid can be produced via electrolysis of sodium hypochlorite, sulfuric acid can be produced via electrolysis of sodium sulfate, and acetic acid can be produced via electrolysis of sodium acetate according to the following equations, respectively:

NaNO₃+H₂O HNO₃+NaOH (19)

NaOCl+H₂O→HOCl+NaOH (20)

Na₂SO₄+H₂O→H₂SO₄+NaOH (21)

NaCH₃COO+H₂O→CH₃COOH+NaOH (22)

As illustrated by Eqs. 19, 20, 21 and 22, NaOH is produced in all reactions. This enables the same CO₂ capture methods to be used in all cases. Note that potassium can be substituted for sodium in all of the above Eqs. 19, 20, 21 and 22. Subsequently, the CO₂ evolution step occurs by mixing the acids produced from Eqs. 19, 20, 21 and 22 with the sodium carbonate to evolve CO₂. Sodium nitrate is a potentially attractive alternative to the electrolysis of sodium chloride as it requires a similar energy in order to drive the reaction. Whereas, the electrolysis of sodium sulfate and sodium acetate require significantly more energy and are unlikely to be economical.

It will be evident to a person skilled in the art that the present invention admits of various other embodiments. Therefore, its scope should be judged by the claims and their legal equivalents.

1. An electrochemical system for a carbon dioxide capture and a carbon dioxide recovery, said electrochemical system comprising:
a) a carbon dioxide capture device comprising an aqueous capture solution substantially composed of a metal hydroxide base solution in water for reacting with carbon dioxide to produce carbonates and bicarbonates during said carbon dioxide capture;
b) an electrochemical stack having at least one electrochemical cell, said at least one electrochemical cell comprising:
1) a gas diffusion anode with a hydrogen supply;
2) a cathode spaced from said gas diffusion anode for defining therebetween an electrolysis region for a salt solution;
3) a cation exchange membrane in said electrolysis region and next to said cathode;
4) a metal hydroxide region separated from said electrolysis region by said cathode;
5) a voltage supply between said gas diffusion anode and said cathode;
whereby a voltage potential applied by said voltage supply produces in said electrolysis region an acid solution at a low concentration, and conditions in said metal hydroxide region said metal hydroxide base solution in water, and evolves hydrogen at said cathode;
c) a carbon dioxide evolution device for said carbon dioxide recovery and a salt recovery of said salt solution by reacting said acid solution from said electrochemical stack with said carbonates and bicarbonates from said carbon dioxide capture device; and
d) a connection for recirculating said salt solution from said salt recovery to said electrochemical stack.

2. The electrochemical system of claim 1, further comprising a hydrogen recirculation connection for feeding hydrogen evolved at said cathode to said hydrogen supply for said gas diffusion anode.

3. The electrochemical system of claim 1, wherein said salt solution in said electrolysis region is a metal chloride.

4. The electrochemical system of claim 3, wherein said metal chloride substantially comprises one of NaCl, CaCl₂, MgCl₂ and KCl or mixtures thereof and wherein said acid solution is hydrochloric acid (HCl).

5. The electrochemical system of claim 1, wherein said salt solution in said electrolysis region is a metal nitrate.

6. The electrochemical system of claim 5, wherein said metal nitrate substantially comprises one of NaNO₃ and KNO₃ or mixtures thereof and wherein said acid solution is nitric acid (HNO₃).

7. The electrochemical system of claim 1, wherein said carbon dioxide capture device, said electrochemical stack and said carbon dioxide evolution device are spatially separated and independently operated.

8. The electrochemical system of claim 1, wherein said metal hydroxide base solution substantially comprises one of NaOH, LiOH, Mg(OH)₂ and KOH or mixtures thereof.

9. The electrochemical system of claim 1, wherein an acid pH of said acid solution in said electrolysis region is greater than 0.3 and a base pH of said metal hydroxide base solution is greater than 10.

10. The electrochemical system of claim 9, wherein said acid pH is greater than 2.

11. The electrochemical system of claim 1, wherein said carbon dioxide capture device interacts with carbon dioxide entrained within a combustion flue or a concentrated carbon dioxide stream.

12. The electrochemical system of claim 1, wherein said carbon dioxide capture device interacts with carbon dioxide in ambient air.

13. The electrochemical system of claim 1, wherein said carbon dioxide capture device comprises at least one trough filled with said aqueous capture solution.

14. The electrochemical system of claim 13, wherein said at least one trough further comprises porous media and said metal hydroxide base solution is deposited over said porous media in a manner that increases an interfacial area between said aqueous capture solution and ambient air.

15. The electrochemical system of claim 1, wherein said carbon dioxide evolution device comprises a pressure vessel such said carbon dioxide recovery yields a pressurized stream of carbon dioxide.

16. The electrochemical system of claim 1, wherein a gap between said gas diffusion anode and said cation exchange membrane is less than 5 millimeters.

17. The electrochemical system of claim 16, wherein said gap

18. The electrochemical system of claim 1, wherein said electrochemical stack has at least two said electrochemical cells connected serially within said electrochemical stack and a spacer is provided between said gas diffusion anode and said cathode to allow for hydrogen gas evolution at said cathode and hydrogen gas consumption at said gas diffusion anode.

19. The electrochemical system of claim 18, wherein said spacer is electrically conductive and electrically connects said cathode and said gas diffusion anode.

20. A method for a carbon dioxide capture and a carbon dioxide recovery, said method comprising:
a) capturing carbon dioxide in a carbon dioxide capture device comprising an aqueous capture solution substantially composed of a metal hydroxide base solution in water that reacts with carbon dioxide to produce carbonates and bicarbonates thereby performing said carbon dioxide capture;
b) providing an electrochemical stack having at least one electrochemical cell, said at least one electrochemical cell comprising:
1) a gas diffusion anode with a hydrogen supply;
2) a cathode spaced from said gas diffusion anode for defining therebetween an electrolysis region for a salt solution;
3) a cation exchange membrane in said electrolysis region and next to said cathode;
4) a metal hydroxide region separated from said electrolysis region by said cathode;
5) a voltage supply;
c) applying a voltage potential by said voltage supply between said gas diffusion anode and said cathode to produce in said electrolysis region an acid solution at a low concentration, and to condition in said metal hydroxide region said metal hydroxide base solution in water, and to evolve hydrogen at said cathode;
d) performing said carbon dioxide recovery and a salt recovery of said salt solution in a carbon dioxide evolution device by reacting said acid solution from said electrochemical stack with said carbonates and bicarbonates from said carbon dioxide capture device; and
e) recirculating said salt solution from said salt recovery to said electrochemical stack.

21. The method of claim 20, further comprising recirculating hydrogen evolved at said cathode to said gas supply for said gas diffusion anode.

22. The method of claim 20, wherein said voltage supply comprises supply of intermittent renewable electricity.

23. The method of claim 20, wherein said acid solution produced in said electrochemical stack is stored and injected continuously into said carbon dioxide evolution device for achieving a substantially continuous supply of carbon dioxide during said carbon dioxide recovery.

24. The method of claim 20, wherein said carbon dioxide capture device comprises at least one trough filled with said aqueous capture solution, and wherein said at least one trough is water-flushed following said carbon dioxide capture to produce a water-flushed aqueous capture solution that is stored prior to being fed to said carbon dioxide evolution device.

25. An electrochemical stack having at least one electrochemical cell, said at least one electrochemical cell comprising:
1) a gas diffusion anode with a hydrogen supply;
2) a cathode spaced from said gas diffusion anode for defining therebetween an electrolysis region for a salt solution;
3) a cation exchange membrane in said electrolysis region and next to said cathode;
4) a metal hydroxide region separated from said electrolysis region by said cathode;
5) a voltage supply between said gas diffusion anode and said cathode;
whereby a voltage potential applied by said voltage supply produces in said electrolysis region an acid solution at a low concentration, and conditions in said metal hydroxide region said metal hydroxide base solution in water, and evolves hydrogen at said cathode.

26. The electrochemical stack of claim 25, further comprising a hydrogen recirculation connection for feeding hydrogen evolved at said cathode to said hydrogen supply for said gas diffusion anode.

27. The electrochemical stack of claim 25, wherein said salt solution in said electrolysis region is a metal chloride.

28. The electrochemical stack of claim 27, wherein said metal chloride substantially comprises one of NaCl, CaCl₂, MgCl₂, and KCl or mixtures thereof and wherein said acid solution is hydrochloric acid (HCl).

29. The electrochemical stack of claim 25, wherein said salt solution in said electrolysis region is a metal nitrate.

30. The electrochemical stack of claim 29, wherein said metal nitrate substantially comprises one of NaNO₃ and KNO₃ or mixtures thereof and wherein said acid solution is nitric acid (HNO₃).

31. The electrochemical stack of claim 25, wherein said carbon dioxide capture device, said electrochemical stack and said carbon dioxide evolution device are spatially separated and independently operated.

32. The electrochemical stack of claim 25, wherein said metal hydroxide base solution substantially comprises one of NaOH, LiOH, Mg(OH)₂ and KOH or mixtures thereof.

33. The electrochemical stack of claim 25, wherein an acid pH of said acid solution in said electrolysis region is greater than 0.3 and a base pH of said metal hydroxide base solution is greater than 10.

34. The electrochemical stack of claim 33, wherein said acid pH is greater than 2.

35. The electrochemical stack of claim 25, wherein a gap between said gas diffusion anode and said cation exchange membrane is less than 5 millimeters.

36. The electrochemical stack of claim 35, wherein said gap is less than 1 millimeter.

37. The electrochemical stack of claim 25, wherein said electrochemical stack has at least two said electrochemical cells connected serially within said electrochemical stack and a spacer is provided between said gas diffusion anode and said cathode to allow for hydrogen gas evolution at said cathode and hydrogen gas consumption at said gas diffusion anode.

38. The electrochemical stack of claim 37, wherein said spacer is electrically conductive and electrically connects said cathode and said gas diffusion anode.
